(19) United States
(12) Patent Application Publication
(10) Pub. No.: US 2009/0162132 A1
(43) Pub. Date: Jun. 25, 2009

(54) APPLICATOR UNIT

(76) Inventors: Robert Frederick Veasey, Warwickshire (GB); John David Cross, Coventry (GB); Robert Perkins, Warwickshire (GB)

Correspondence Address: NOVARTIS;CORPORATE INTELLECTUAL PROPERTY, ONE HEALTH PLAZA 104/3, EAST HANOVER, NJ, 07936-1080, US

(21) Appl. No.: 12/304,163

(22) PCT Filed: Jun. 28, 2007
(86) PCT No.: PCT/EP07/05742

§ 371 Date: Dec. 10, 2008

(30) Foreign Application Priority Data
Jun. 30, 2006 (GB) 0613057.9

(51) Int. Cl. A45D 34/04; B05B 11/04

(52) U.S. Cl. 401/186; 401/202

(57) ABSTRACT

An applicator unit for use in applying a substance to a surface, the applicator unit comprising: a body unit to which a pressurizable container is in use attached; and an outlet unit which includes an applicator element to which substance is dispensed and a valve member which is movably disposed relative to the applicator element between a first, closed configuration in which the outlet unit is closed and a second, open configuration in which the outlet unit is opened such as to establish a communication path between the container and the applicator element, wherein the valve member is configured to be moved to the open configuration on pressurisation of the container, thereby providing for dispensing of substance to the applicator element.

The present invention relates to an applicator unit for use in applying a substance, in particular a viscous substance, such as a pharmaceutical product or a cosmetic product, to a surface, such as a human nail.

WO-A-2004/062422 discloses an applicator device for applying a nail polish. This applicator device includes a pump mechanism for delivering nail polish to a brush for subsequent application to a nail.

It is an aim of the present invention to provide an improved device.

In one aspect the present invention provides an applicator unit for use in applying a substance to a surface, the applicator unit comprising: a body unit to which a pressurizable container is in use attached; and an outlet unit which includes an applicator element to which substance is dispensed and a valve member which is movably disposed relative to the applicator element between a first, closed configuration in which the outlet unit is closed and a second, open configuration in which the outlet unit is opened such as to establish a communication path between the container and the applicator element, wherein the valve member is configured to be moved to the open configuration on pressurisation of the container, thereby providing for dispensing of substance to the applicator element.

Preferably, the container is a compressible container, with the container being pressurized on compression of the container, for example through a user squeezing said container.

The applicator element and the valve member may include counterpart seat elements which are in sealing engagement when the applicator element and the valve member are in the closed configuration and separated when the applicator element and the valve member are in the open configuration.

The applicator element may include a body section, which includes an annular seat element disposed thereabout, and an applicator tip which extends from the body section, and the valve member includes an annular section which is slideably disposed over the body section of the applicator element and includes an annular seat element, with the seat elements being in sealing engagement when the applicator element and the valve member are in the closed configuration and separated when the applicator element and the valve member are in the open configuration, such as to establish a fluid communication path for delivery of substance to the applicator tip.

In one embodiment the applicator tip comprises a paddle.

Preferably, the applicator tip includes at least one application surface.

The applicator tip may include at least one ducting channel which extends from the annular seat to the at least one application surface, such as preferentially to direct substance to the application surface.

In one embodiment the applicator tip includes first and second oppositely-directed application surfaces.

In another embodiment the applicator tip comprises a porous element.

In a further embodiment the applicator tip comprises a brush element.

Preferably, the applicator unit further comprises: a cap which is fittable to the body unit such as to enclose the applicator element.

Preferably, the cap is configured to engage the valve member when fitted to the body unit, such as to lock the applicator element and the valve member in the closed configuration.

In one embodiment the valve member includes an annular seat element, and the cap includes a cavity which has an open end for receiving the applicator element, and an annular seat element which is disposed about the open end of the cavity, with the annular seat elements being configured such that, when the cap is fitted to the body unit, the annular seat elements are sealingly engaged and the applicator element and the valve member are locked in the closed configuration.

Preferably, the outlet unit includes a biasing element for biasing the applicator element and the valve member to the closed configuration.

In one embodiment the outlet unit includes a support member from which extends the applicator element, the support member including an internal surface which is in fluid communication with the container, an external surface which is in fluid communication with atmosphere and may include at least one venting aperture which provides an air relief path into the container. There may also be provided a sealing member which is disposed at the internal surface of the support member such as to normally to close the at least one venting aperture and allow an air flow into the container in the presence of a reduced pressure in the container.

In another embodiment the outlet unit includes a support member which is integrally formed with at least part of the applicator element. The support member may be formed integrally with the body section of the applicator element with the applicator tip extending therefrom. The combined support member and applicator element may include one or more vent holes as described above and may also include a sealing member for normally sealing said one or more vent holes as described above.

In one embodiment the sealing member comprises a resilient member which normally overlies the at least one venting aperture and is deflectable such as to open the at least one venting aperture.

In one embodiment the valve member includes a seat element which is configured to overly the external surface of the support member and close the at least one venting aperture therein when the applicator element and the valve member are in the closed configuration and be separated from the external surface of the support member when the applicator element and the valve member are in the open configuration, such as to allow for an air flow through the at least one venting aperture into the container.

In one embodiment the valve member is in sliding sealing engagement with the support member.

In another aspect the present invention provides an applicator unit for use in applying a substance to a surface, the applicator unit comprising: an outlet unit which includes an applicator element to which substance is dispensed, and a valve member which is operative to allow substance to be dispensed to the applicator element.

The present invention also extends to an applicator device comprising the above-described applicator unit and a container for containing a substance.

In one embodiment the container contains a substance.

In one embodiment the substance comprises a pharmaceutical product.

In another embodiment the substance comprises a cosmetic product.

A preferred embodiment of the present invention will now be described hereinbelow by way of example only with reference to the accompanying drawings, in which:

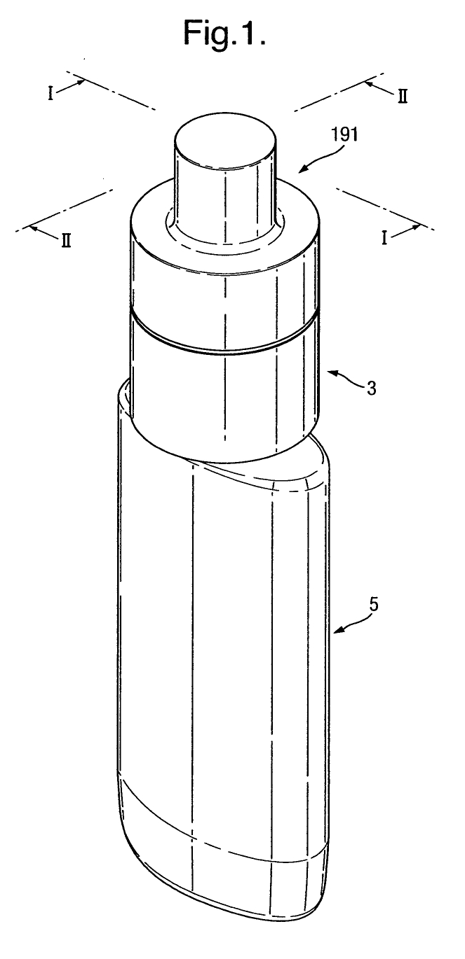

FIG. 1 illustrates a perspective view of an applicator device in accordance with an embodiment of the present invention;

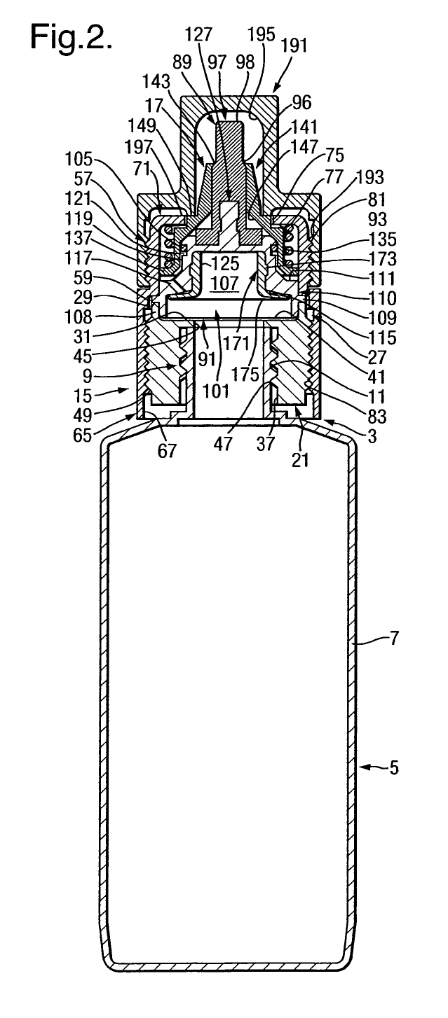

FIG. 2 illustrates a cross-sectional view (along section I-I in FIG. 1) of the applicator device of FIG. 1, where illustrated in the rest, closed or inoperative configuration;

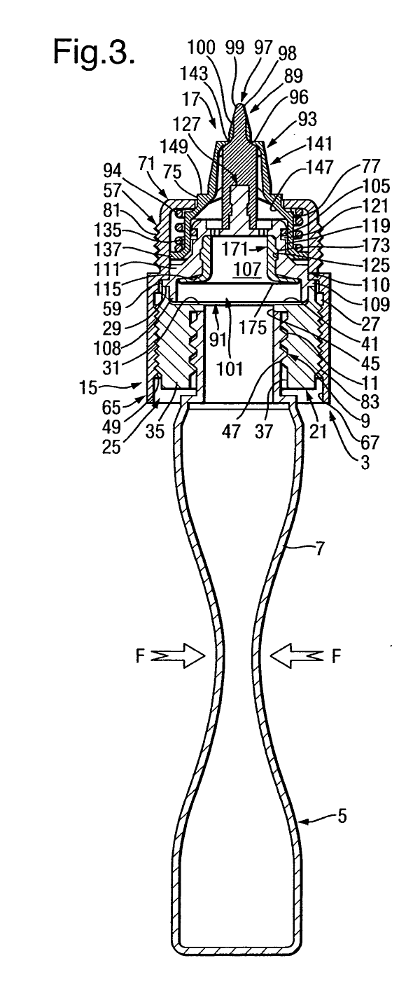

FIG. 3 illustrates a cross-sectional view (along section II-II in FIG. 1) of the applicator device of FIG. 1, where illustrated in the open or operative configuration;

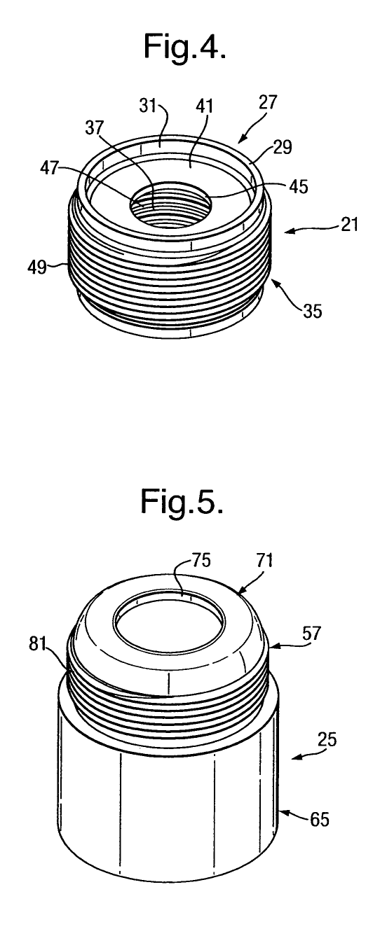

FIG. 4 illustrates a perspective view of the first body member of the body unit of the applicator unit of FIG. 1;

FIG. 5 illustrates a perspective view of the second body member of the body unit of the applicator unit of FIG. 1;

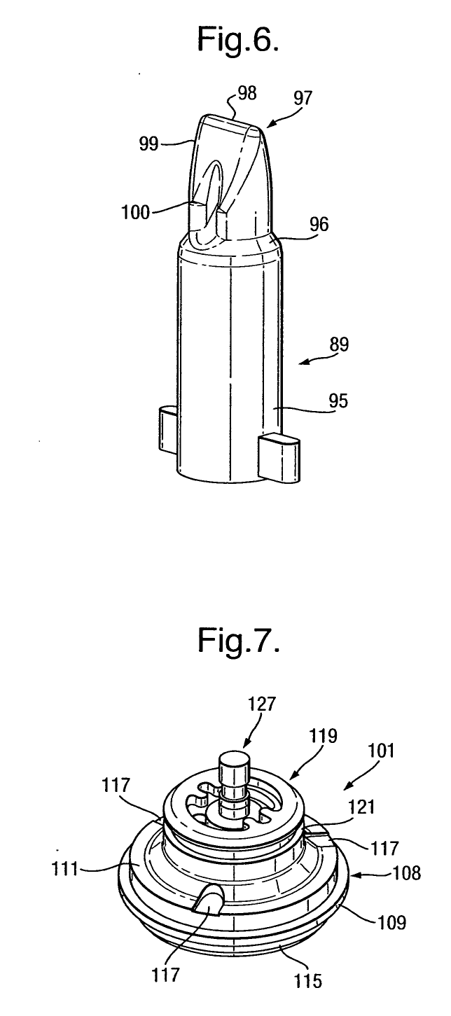

FIG. 6 illustrates a perspective view of the applicator element of the outlet unit of the applicator unit of FIG. 1;

FIG. 7 illustrates a perspective view of the support member of the support unit of the outlet unit of the applicator unit of FIG. 1;

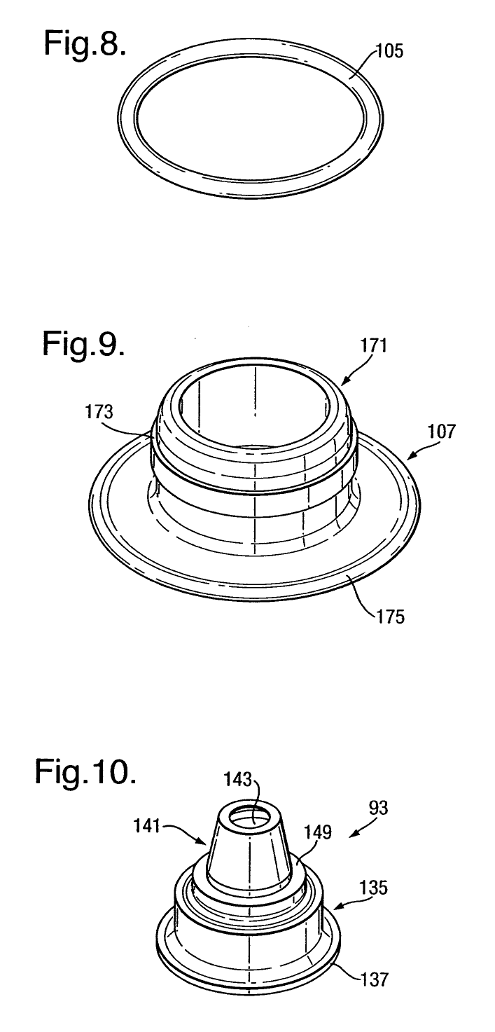

FIG. 8 illustrates a perspective view of the of the first sealing member of the support unit of the outlet unit of the applicator unit of FIG. 1;

FIG. 9 illustrates a perspective view of the of the second sealing member of the support unit of the outlet unit of the applicator unit of FIG. 1;

FIG. 10 illustrates a perspective view of the valve member of the outlet unit of the applicator unit of FIG. 1;

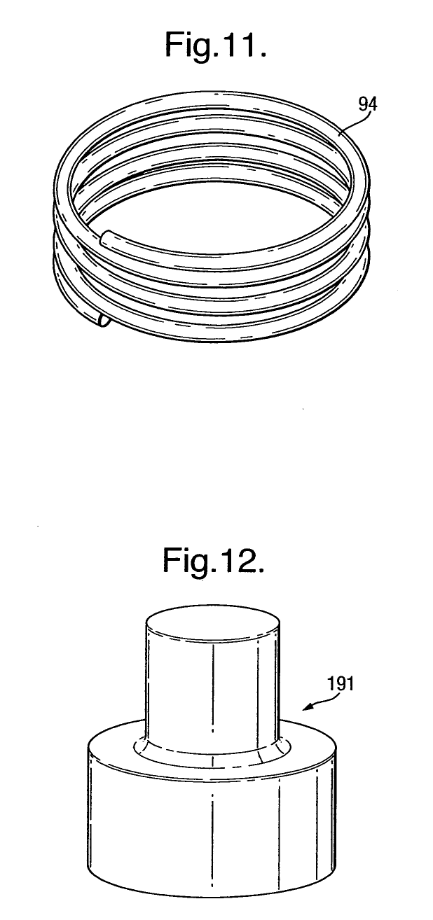

FIG. 11 illustrates a perspective view of the biasing element of the outlet unit of the applicator unit of FIG. 1;

FIG. 12 illustrates a perspective view of the cap of the applicator unit of FIG. 1;

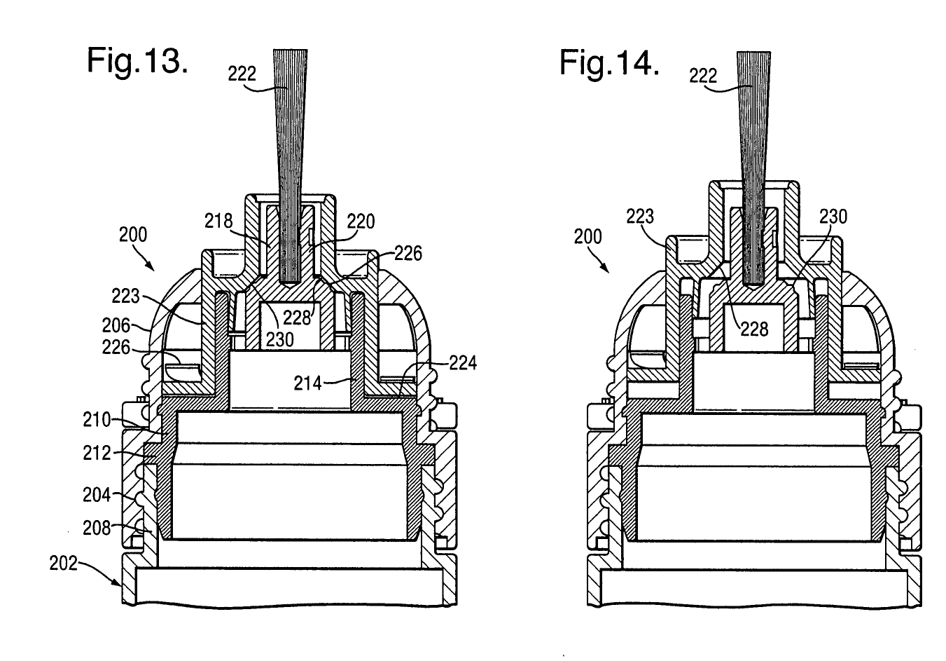

FIG. 13 illustrates a different embodiment with the valve closed; and

FIG. 14 illustrates the embodiment of FIG. 13 with the valve open.

The applicator device comprises an applicator unit 3 and a container 5 which is fluidly connected to the applicator unit 3.

In this embodiment the container 5 comprises an elongate container body 7 and a head member 9 at one, the forward, end of the container body 7, which includes a threaded section 11, in this embodiment as an external thread, which provides for coupling to the applicator unit 3, as will be described in more detail hereinbelow.

In this embodiment the container body 7 is formed at least in part of a flexible material such as to allow for compression of the same to deliver substance to the applicator unit 3.

In preferred embodiments the container 5 is formed of one of polypropylene (PP), polyethylene (PE), poly(ethylene terephthalate) (PET), polyamide (PA), ethylene/vinyl alcohol (EVOH), cyclic olefin co-polymer (COC) such as Topas®, or the container can have a multilayered structure by using the plastics described above.

The applicator unit 3 includes a body unit 15 which is attached to the head member 9 of the container 5, and an outlet unit 17 which is coupled to the body unit 15 and from which substance is delivered for topical application to a surface, such as a human nail.

The body unit 15 comprises a first body member 21 which is coupled, in this embodiment threadedly coupled, to the head member 9 of the container 5, and a second body member 25 which is coupled, in this embodiment threadedly coupled, to the first body member 21, with the outlet unit 17 being coupled to the body unit 15 by captive engagement between the first and second body members 21, 25, optionally the body members can be integrated into one single component.

Referring particularly to FIG. 4, in this embodiment the first body member 21 includes a forward section 27 which comprises a seat element 29, in this embodiment an annular seat, and includes a first cavity 31, in this embodiment of cylindrical section, a rear section 35 which extends rearwardly of the forward section 27 and includes a second cavity 37, in this embodiment of cylindrical section, and a flange section 41 which is intermediate the first and second cavities 31, 37 and includes a fluid communication aperture 45 which provides for fluid communication between the first and second cavities 31, 37.

In this embodiment the rear section 35 of the first body member 21 includes a first thread coupling 47, here in the inner peripheral surface thereof, to which the thread coupling 11 on the head member 9 of the container 5 is threadedly engaged, and a second thread coupling 49, here in the outer peripheral surface thereof, to which the second body member 25 is threadedly engaged, as will be described in more detail hereinbelow.

Referring particularly to FIG. 5, in this embodiment the second body member 25 includes a forward section 57 which includes a seat element 59, in this embodiment a rearwardly-directed annular seat, which, as will be described in more detail hereinbelow, opposes the seat element 29 of the first body member 21, a rear section 65 which extends rearwardly of the forward section 57 and includes a second cavity 67, in this embodiment of cylindrical section, which receives the first body member 21, and a flange section 71 which is located at the forward, distal end of the forward section 57 and includes an aperture 75 through which the outlet unit 17 projects and defines a seat element 77, in this embodiment a rearwardly-directed annular seat.

In this embodiment the forward section 57 of the second body member 25 includes a first thread coupling 81, here in the outer peripheral surface thereof, to which a cap 191 is threadedly engaged, as will be described in more detail hereinbelow.

In this embodiment the rear section 65 of the second body member 25 includes a second thread coupling 83, here in the inner peripheral surface thereof, to which the second thread coupling 49 on the first body member 35 is threadedly engaged.

In preferred embodiments the first and second body members 21, 25 are formed of one of PP, polyacetal (POM), poly(butylene terephthalate) (PBT) or PE.

The outlet unit 17 comprises an applicator element 89 to which substance is delivered for application to a surface, a support unit 91 which is attached to the body unit 15 and supports the applicator element 89, a valve member 93, which is movably disposed relative to the support unit 91 between a first, closed position, as illustrated in FIG. 2, in which the outlet unit 17 is closed, and a second, open position, as illustrated in FIG. 3, in which a fluid communication path is established between the container 5 and the applicator element 89 such as to provide for the delivery of substance to the applicator element 89 on compressing the container 5, and a biasing element 94 which acts to bias the valve member 93 to the closed position.

Referring particularly to FIG. 6, the applicator element 89 comprises a base section 95 which is a attached to the support unit 101, a seat element 96, in this embodiment a tapering annular seat, at a forward end of the base section 95 which sealing engages the valve member 93 when the valve member 93 is biased to the closed position by the biasing element 94, and an applicator tip 97, in this embodiment a resilient element, which extends forwardly of the seat element 96 to which substance is delivered for application to a surface.

In this embodiment the applicator tip 97 includes an application edge 98 and at least one, in this embodiment a pair of oppositely-directed application surfaces 99 which extend rearwardly of the application edge 98.

In this embodiment the applicator tip 97 includes at least one, in this embodiment a pair of ducting channels 100 which extend from the seat element 96 to the respective application surfaces 99, such as preferentially to direct substance to the application surfaces 99.

In preferred embodiments the applicator tip 97 is formed of a metallocene polyolefin, polyolefin plastomer or thermoplastic polyester elastomer.

In an alternative embodiment the applicator tip 97 could comprise a porous element, the forward end of which is shaped in the form of a pointed nib. In one embodiment the porous element could be formed from a fibre pad, typically in the form of a felt pad, or an open-cell foam.

In another alternative embodiment the applicator tip 97 could comprise a brush element, where the fluid is delivered into the body of the bristles of the brush element. In one preferred embodiment the bristles could be formed of PA, PET, PP, PE or natural fibers.

The support unit 91 comprises a support member 101 which is attached to the body unit 15, a first sealing member 105 which is disposed to an outer surface of the support member 101 and sealingly engages with the valve member 93, and a second sealing element 107 which is disposed to an inner surface of the support member 101 and acts normally to close at least one venting aperture 117 in the support member 101, as will be described in more detail hereinbelow.

Referring particularly to FIG. 7, the support member 101 comprises a rear section 108, in this embodiment an annular section, which includes an outwardly-extending attachment element 109, in this embodiment an annular flange, which is engaged between the body members 21, 25 of the body unit 15 such as to fix the support member 101 to the body unit 15, a flange section 110 which extends inwardly from a forward end of the rear section 108 and includes a first, forwardly-directed surface 111, a second, rearwardly-directed surface 115 and at least one, in this embodiment a plurality of venting apertures 117 which extend between the first and second surfaces 111, 115, a forward section 119, in this embodiment an annular section of a smaller diametral dimension than the rear section 108, which extends forwardly of the flange section 110 and includes a first recess 121, in this embodiment an annular groove, in an outer peripheral surface thereof, which receives the first sealing element 105 and a second recess 125, this embodiment an annular groove, in an inner peripheral surface thereof which acts to engage a projection 173 on the second sealing element 107 such as to fix the second sealing element 107 to the support member 101, and a support section 127 which extends from the forward section 119 to which the applicator element 89 is attached.

In preferred embodiments the support member 101 is formed of one of PP, POM, PBT or PE.

Referring particularly to FIG. 8, in this embodiment the first sealing member 105 comprises a resilient sealing ring, here an O-ring formed of a metallocene polyolefin, polyolefin plastomer or thermoplastic polyester elastomer.

Referring particularly to FIG. 9, the second sealing member 107 comprises a forward, attachment section 171, in this embodiment an annular section, which includes a projection 173, in this embodiment an annular bead, on the outer surface thereof which is engaged in the second, inner recess 125 in the forward section 119 of the support member 101 such as to hold the second sealing member 107 captive to support member 101, and a rear, sealing section 175 which extends outwardly from the rear end of the attachment section 171 such as normally to overly the rearwardly-directed surface 115 of the flange section 110 of the support member 101 and seal the at least one venting aperture 117 in the flange section 109 of the support member 101.

In this embodiment the sealing section 175 is a flexible section which normally overlies the rearwardly-directed surface 115 of the flange section 110 of the support member 101 and seals the at least one venting aperture 117 in the flange section 110 of the support member 101, particularly on compression of the container 5 to deliver substance from the outlet unit 17 to the applicator element 89 thereof, where the compression of the contained substance acts to press the sealing section 175 against the rearwardly-directed surface 115 of the flange section 110 of the support member 101, but, on releasing the compressive force as applied to the container 5, air is drawn through the at least one venting aperture 117 which deflects the sealing section 175 rearwardly from the rearwardly-directed surface 115 of the flange section 110 of the support member 101, such as to vent air into the container 5.

In preferred embodiments the second sealing member 107 is formed of a metallocene polyolefin, polyolefin plastomer or thermoplastic polyester elastomer.

Referring particularly to FIG. 10, the valve member 93 comprises a rear section 135, in this embodiment an annular section, which is slideably disposed, in sealing engagement, over the forward section 119 of the support member 101 and includes a seat element 137, in this embodiment an outwardly-directed annular flange, at the rear end thereof which is normally seated on the forwardly-directed surface 111 of the flange section 110 of the support member 101 under the bias of the biasing element 94 such as to close the at least one venting aperture 117, a forward section 141, in this embodiment an annular section, which is slideably disposed over the applicator element 89 and includes a sealing element 143, in this embodiment an annular lip, at the inner peripheral surface thereof which sealingly engages the seat element 96 on the applicator element 89 when the valve member 93 is biased to the closed position by the biasing element 94, and a flange section which interconnects the rear and forward sections 135, 141 and includes a rearwardly-directed, pressure-receiving surface 147, which presents a surface area against which acts the pressure as developed in the substance by compression of the container 5 such as to drive the valve member 93 forwardly to open the outlet unit 17 and provide for the delivery of substance to the applicator element 89, and a seat element 149, in this embodiment an annular seat, which provides an engagement surface for a cap 191 as will be described in more detail hereinbelow.

In preferred embodiments the valve member 93 is formed of one of PP, PE, PBT or POM.

Referring particularly to FIG. 11, in this embodiment the biasing element 94 comprises a resilient element, here a compression spring.

In a preferred embodiment the biasing element 94 is formed of stainless steel, a metallocene polyolefin, polyolefin plastomer or thermoplastic polyester elastomer.

Referring particularly to FIG. 12, the applicator unit 3 further comprises a cap 191 which a sealing fit with the body unit 15 such as to enclose the applicator element 89 of the outlet unit 17 from the atmosphere.

In this embodiment the cap 191 includes a thread coupling 193, here in the inner peripheral surface thereof, which is counterpart to the thread coupling 81 on the forward section 57 of the body unit 15.

In this embodiment the cap 191 includes a cavity 195 which includes an open rear end and a seat element 197, in this embodiment a rearwardly-directed annular seat, which is disposed about the open rear end of the cavity 195. The seat element 197 is configured such as to engage the seat element 149 on the valve member 93 of the outlet unit 17 when the cap 191 is fitted to the body unit 15. With this configuration, the cap 191 acts to lock the valve member 93 of the outlet unit 17 in the closed position, as illustrated in FIG. 2, such as to prevent substance from inadvertently being dispensed from the container 5, and also encloses the applicator element 89 in the cavity 195 thereof.

In a preferred embodiment the cap 191 is formed of PP, PE, PBT or POM.

Operation of the above-described delivery device will now be described hereinbelow.

With a container 5 fitted to the applicator unit 3, the user first removes the cap 191 from the body unit 15 to expose the applicator element 89 of the outlet unit 17.

The user then compresses the body 7 of the container 5, in this embodiment by manually squeezing the body of the container 5, as illustrated in FIG. 3.

This compression of the container 5 acts to force substance from the container 5 into the applicator unit 3. The pressure as developed in the substance acts to bias the sealing section 175 of the second sealing member 107 of the support unit 101 to the closed position and also acts on the pressure-receiving surface 147 of the valve member 93 to move the valve member 93 forwardly relative to the applicator element 89 against the biasing force of the biasing element 94. This movement of the valve member 93 acts to release the sealing element 143 of the valve member 93 from the seat element 96 on the applicator unit 89 and open a fluid communication path to the applicator tip 97 of the applicator element 89 and provide for the delivery of substance to the applicator tip 97, in this embodiment to the application surfaces 99 of the applicator tip 97 through the ducting channels 100 therein.

On releasing the compressive force as applied to the container 5, the valve member 93 is returned to the closed position, as illustrated in FIG. 2, under the bias of the biasing element 94 of the outlet unit 17, such as to close the outlet unit 17, and the reduced pressure as generated within the container 5 acts to draw air into the container 5 through the at least one venting aperture 117 in the support member 119 of the support member 101, with the sealing section 175 of the second sealing member 107 of the support unit 101 being deflected to allow for an air flow into the container 5.

If further substance is required for application, this procedure is repeated.

FIG. 13 shows a different embodiment of an applicator unit 200 which is coupled to a container 202 (similar to the container 5) of FIG. 1 using a screw thread 204. The internal screw thread is formed on an outer body member 206 and the external screw thread on the head member 208 of the container 202. An inner body 210 includes a flange 212 that is trapped between the head member 208 of the container body 202 and the outer body member 206.

The inner body member 210 comprises a support member 214 and an applicator element 216. The support member 214 extends into the head member 208 of the container 202 rearward of the flange 212 and forwards of the flange 212 to support the applicator element 218. The applicator element comprises an applicator body 220 from which a brush element 222 extends.

A valve member 223 is slidably mounted to the inner body member 210 and is located between a forwardly directed shoulder 224 on the inner body member 210 and the outer body member 206. A biasing spring 226 biases the valve member to the closed position (as shown in this Figure). In the closed position a seal 226 is formed between a seal portion 230 of the applicator element 218 located on the applicator body 220 and a valve seal portion 228 of the valve member 223.

FIG. 14 shows the applicator unit 200 of FIG. 13 with the valve member 223 in the open position. In the open position the valve member 223 is forced away from the container 202, compressing the biasing spring 226, by the pressure generated in the container 202 through squeezing of said container 202. The valve slides forward so that the seal 226 is broken as the seal portions 228, 230 are separated. This allows fluid from within the container 202 to pass from the container 202 to the applicator element 218 and onto the applicator tip, in this case the brush element 222. When the squeezing force on the container is released thereby releasing the pressure in the container 202 the biasing spring 226 acts to return the valve member 223 to the closed position such that seal 226 is reformed.

It should be understood that the various material options noted above may also be suitable for this embodiment. Although not shown in FIGS. 13 and 14 a vent which could be formed through the inner body member 210 to provide the function described above. A second sealing element similar to the second sealing element 107 of the previous figures could be used to seal the vent which could be formed through the inner body member 210. A different second sealing element could also be used.

An external thread 232 is provided on the outer housing 206 which is adapted to cooperate with an internal thread on a cap (not shown) to secure the cap to the outer housing 206. The cap, when secured to the outer housing engages with at least a portion of the valve member and retains the valve member in the closed positon.

Finally, it will be understood that the present invention has been described in its preferred embodiment and can be modified in many different ways without departing from the scope of the invention as defined by the appended claims.

1. An applicator unit for use in applying a substance to a surface, the applicator unit comprising:
a body unit to which a pressurizable container is in use attached; and
an outlet unit which includes an applicator element to which substance is dispensed and a valve member which is movably disposed relative to the applicator element between a first, closed configuration in which the outlet unit is closed and a second, open configuration in which the outlet unit is opened such as to establish a communication path between the container and the applicator element, wherein the valve member is configured to be moved to the open configuration on pressurisation of the container, thereby providing for dispensing of substance to the applicator element.

2. The applicator unit of claim 1, wherein the container is a compressible container, with the container being pressurized on compression of the container and the applicator element and the valve member include counterpart seat elements which are in sealing engagement when the applicator element and the valve member are in the closed configuration and separated when the applicator element and the valve member are in the open configuration.

3. The applicator unit of claim 2, wherein the applicator element includes a body section, which includes an annular seat element disposed thereabout and an applicator tip which extends from the body section, and the valve member includes an annular section which is slideably disposed over the body section of the applicator element and includes an annular seat element, with the seat elements being in sealing engagement when the applicator element and the valve member are in the closed configuration and separated when the applicator element and the valve member are in the open configuration, such as to establish a fluid communication path for delivery of substance to the applicator tip, the applicator tip including at least one application surface and at least one ducting channel which extends from the annular seat to the at least one application surface, such as preferentially to direct substance to the application surface.

4. The applicator unit of claim 1, further comprising a cap which fittable to the body unit such as to enclose the applicator element, the cap being configured to engage the valve member when fitted to the body unit, such as to lock the applicator element and the valve member in the closed configuration.

5. The applicator unit of claim 4, wherein the valve member includes an annular seat element, and the cap includes a cavity which has an open end for receiving the applicator element, and an annular seat element which is disposed about the open end of the cavity, with the annular seat elements being configured such that, when the cap is fitted to the body unit, the annular seat elements are sealingly engaged and the applicator element and the valve member are locked in the closed configuration.

6. The applicator unit of claim 1, wherein the outlet unit includes a biasing element for biasing the applicator element and the valve member to the closed configuration.

7. The applicator unit of claim 1, wherein the outlet unit includes a support member from which extends the applicator element, the support member including an internal surface which is in fluid communication with the container, an external surface which is in fluid communication with atmosphere and at least one venting aperture which provides an air relief path into the container, and a sealing member which is disposed at the internal surface of the support member such as to normally to close the at least one venting aperture and allow an air flow into the container in the presence of a reduced pressure in the container.

8. The applicator of claim 7, wherein the sealing member comprises a resilient member which normally overlies the at least one venting aperture and is deflectable such as to open the at least one venting aperture.

9. The applicator unit of claim 7, wherein the valve member includes a seat element which is configured to overly the external surface of the support member and close the at least one venting aperture when the applicator element and the valve member are in the closed configuration and be separated from the external surface of the support member when the applicator element and the valve member are in the open configuration, such as to allow for an air flow through the at least one venting aperture into the container.

10. The applicator unit of claim 7, wherein the valve member is in sliding sealing engagement with the support member.

11. An applicator device comprising the applicator unit of claim 1 and a container for containing a pharmaceutical product.

12-25. (canceled)
